(19) United States
(12) Patent Application Publication
(10) Pub. No.: US 2006/0268282 A1
(43) Pub. Date: Nov. 30, 2006

(54) Adaptive nulls for testing off-axis segments of aspherics

(76) Inventors: Christopher J. Evans, Higganum, CT (US); Christoph G. Kuechel, Jena (DE); Robert E. Parks, Tucson, AZ (US); William P. Kuhn, Tucson, AZ (US)

Correspondence Address: FRANCIS J. CAUFIELD, 6 APOLLO CIRCLE, LEXINGTON, MA, 02421-7025, US

(21) Appl. No.: 11/438,885

(22) Filed: May 23, 2006

Related U.S. Application Data
(60) Provisional application No. 60/684,291, filed on May 25, 2005.

(51) Int. Cl. G01B 11/02

(52) U.S. Cl. 356/515

(57) ABSTRACT

A Fizeau interferometer is provided with an adaptive null optic whose shape may be selectively varied in a controllable way by the selective application of external mechanical loads to enable the interferometer to be dynamically adapted to testing a variety of aspherical segments of differing shapes without the need for providing individual reference surfaces to match the various shapes of each test segment.

### CROSS-REFERENCE TO RELATED APPLICATION

This application claims the benefit of priority from U.S. Provisional Patent Application No. 60/684,291 filed on May 25, 2005 in the name of Christopher J. Evans, et al. and entitled ADAPTIVE NULLS FOR TESTING OFF-AXIS SEGMENTS OF ASPHERICS, the entire contents of which is incorporated herein by reference.

### FIELD OF THE INVENTION

This invention in general relates to interferometric apparatus and in particular to interferometric apparatus using adaptive null optics for measuring aspherical segments of differing shape.

### BACKGROUND OF THE INVENTION

There are a variety of circumstances that make it desirable to interferometrically test a segment of an aspheric optical surface or wavefront that does not include the axis of symmetry. Consider, for example, a conic (e.g., parabolic or ellipsoidal) primary mirror for a telescope comprising a number of independent segments—such as the Keck telescopes on Hawaii or the proposed Thirty Meter Telescope (e.g., see website http://www.tmt.org). The individual segments differ from the best-fit sphere dominantly by astigmatism, which increases monotonically as segments are taken further from the axis.

Such segments, and other off-axis mirrors, are commonly tested in a so-called “null” configuration where the test or reference wavefront is adapted to match the part under test. Such nulls may be computer generated holograms (e.g., Pan F. Y., and Burge J. H “Efficient testing of segmented aspherical mirrors using a reference plate and computer generated holograms: 1. Theory” Applied Optics (2004) 43, pp 5303-12; Pan F. Y., Burge J. H, Anderson D, and Poleshchuk “Efficient testing of segmented aspherical mirrors using a reference plate and computer generated holograms: 2. Case study, error analysis and experimental validation” Applied Optics (2004) 43, pp 5313-22), refractive lenses, or combinations of mirrors. Separate nulls (or different set-ups) are required for every part to be tested. The design for the Thirty Meter Telescope, for example, calls for 123 different segments.

The segments themselves may be fabricated by a process known as “bend and polish” (Mast T. S., Nelson J. E. and Sommargren G. E. “Primary Mirror Segment Fabrication for CELT” Proc. SPIE Vol 4003 (2000) 43-58), in which an optical blank is bent to a predetermined aspheric shape, polished, and then allowed to spring back to give the desired asphere. We have recognized that the same bending approach can be adapted to provide a continuously variable null that can be used to test any segment of a telescope or other optic containing segmented aspheres. Clearly, this idea can apply to testing a broad range of off-axis optics, including sub-aperture testing of large optics—for example, in applications where it is desired to stitch together many sub-aperture measurements to create a high-resolution map of a surface.

Consequently, it is a primary object of the present invention to provide interferometric apparatus and methods for measuring a broad range of off-axis optics of differing shape.

It is another object of the invention to provide an adaptive null optic whose shape can be dynamically altered for interferometrically testing a variety of aspherical segments of differing shape.

Other objects of the invention will, in part, be obvious and will, in part, appear hereinafter when the following detailed description is read in connection with the accompanying drawings.

### SUMMARY OF THE INVENTION

A Fizeau interferometer is provided with an adaptive null optic whose shape may be selectively varied in a controllable way by the selective application of external mechanical forces to enable the interferometer to be dynamically adapted to testing a variety of aspherical segments of differing shapes without the need for providing individual reference surfaces to match the various shapes of each test segment.

More generally, the invention comprises an interferometer apparatus for testing aspheric optical segments comprising a support arrangement for holding and manipulating an aspheric optical segment under test. An adaptive null optic, located upstream of the aspheric optical segment under test is provided such that its shape is controllably changeable by the selective application of external mechanical forces. A transmission sphere having a reference surface is located forward of the adaptive null optic, and a mainframe interferometer subsystem is provided for generating a known plane or spherical wavefront whose shape matches that of the reference surface and is further modified by the adaptive null optic so that after leaving the null optic impinges on the aspherical segment under test with a shape substantially matching it.

In this manner, controlled, calibrated bending of a refractive or reflective element in an interferometric test-set-up, e.g., a Fizeau cavity, minimizes the difference between the reference wavefront and test wavefront to:
(1) Keep the difference between the wavefronts within the dynamic range of the detector in the interferometer
(2) Minimize the systematic errors (e.g., retrace errors) introduced into the measurement by the difference.

While described here as used in a Fizeau configuration, it will be obvious to those versed in the art that the same ideas may be applied to other interferometric configurations, including but not limited to Mach-Zehnder and Twyman-Green configurations.

### BRIEF DESCRIPTION OF THE DRAWINGS

The structure, operation, and methodology of the invention, together with other objects and advantages thereof, may best be understood by reading the detailed description in connection with the drawings in which each part has an assigned numeral that identifies it wherever it appears in the various drawings and wherein:

FIG. 1 is a diagrammatic elevational view of an in-cavity adaptive, reflective null shown in a Fizeau arrangement;

FIG. 2 is a simulated interferogram showing the effects of using the inventive adaptive null in testing an off-axis toroidal segment;

FIG. 3. shows schematically the optical configuration for a Fizeau test where the reference surface of the transmission sphere is bent to match the part under test; and

FIG. 4. shows zones of calculated deflection for 200 micron PV bending of a 40 mm thick, 1.3 m diameter Zerodur® mirror blank showing acceptable stresses and required moments less than 100 Nm.

### DETAILED DESCRIPTION

This invention relates to the provision of an adaptive null optic in an interferometer, especially a Fizeau, for the purpose of measuring a variety of aspherical segments of different shapes. As will been seen, the shape of the adaptive null optic may be selectively varied in a controllable way by the selective application of external mechanical forces to enable the interferometer to be dynamically adapted to testing a variety of aspherical segments of differing shapes without the need for providing individual reference surfaces to match the various shapes of each test segment.

One general feature of this invention is to use bending of a smooth optical element to reduce the effect of the low order (and typically largest amplitude) differences between a reference wavefront (usually spherical) and the surface or wavefront under test. At minimum, this bending should bring the difference within the dynamic range of the detector used in the interferometer. Further, systematic errors arising from the interferometric test are substantially reduced as the difference between reference and test wavefronts is reduced. While usually spherical, it will be understood that the reference wavefront can also be aspheric in shape.

One test configuration places a fold within a Fizeau cavity, giving in essence the Ritchey-Common configuration for the testing of large flats in a spherical cavity. Power (i.e., a rotationally invariant quadratic term) in the flat gives both power and astigmatism in the wavefront, a fact applied by users of the Ritchey-Common test (for example, Kuechel M “Absolute Measurement of Flat Mirrors in the Ritchey-Common Test” “Proc OSA, OF&T 1986, Shu K. L. ” Ray-trace Analysis and Data Reduction Methods for the Ritchey-Common Test, Appl Opt. 22 (1983) 1879-86, Parks R. E., Evans C. and Shao, L. Z. “Absolute Ritchey_Common Test for Circular Flats” Proc OSA, OF&T, 1998) to separate the errors.

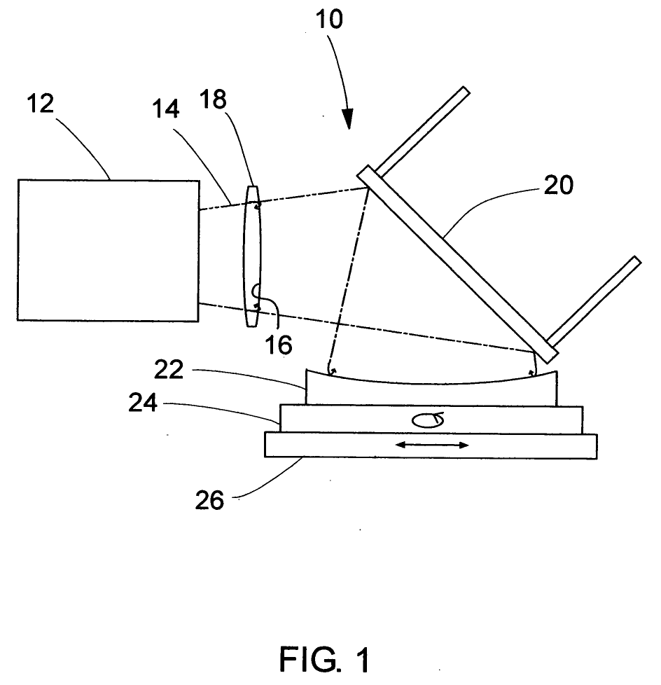

A conventional null solution would be to deliberately shape the flat so that the wavefront matches a specific part to be tested. For a project such as the Thirty Meter Telescope, the number of nulls require can be reduced by giving the flat intermediate power and astigmatism to cover a range of segments to be measured with acceptable fringe densities on the detector. An active solution as provided by the invention involves adding a bending harness to the fold mirror as illustrated in FIG. 1. As seen in FIG. 1, there is an interferometric apparatus 10 comprising a mainframe interferometer subsystem 12 that generates a spherical wavefront 14 that impinges on the reference surface 16 of a transmission sphere 18 (TS) and is further shaped downstream by the adaptive fold mirror 20, appropriately bent, so that the resultant wavefront reflected from it substantially matches that of the mirror segment 22 under test. The mainframe interferometer subsystem 12 comprises a source suitable for interferometric applications, beam combining optics, imaging optics, a detector suitable for imaging interferograms, signal processing electronics, and data processing electronics. A computer may also be used for data processing, electronic control, user interfacing, and general housekeeping. The segment under test is mounted atop a precision rotary table 24 that in turn sits atop a precision linear slide 26 both of whose movements are precisely controlled in well-known manners as, for example, with electronic controllers or computers provided with suitable control boards.

After a test segment 22 has been measured, another segment of different shape may then replace the prior test segment with the adaptive null surface 20 bent to accommodate this new shape. This process is repeated until all segments within the dynamic range of the adaptive null have been tested. In this case, any desired astigmatism and power can be supplied, effectively providing an adaptive null. For the specific case of the Thirty Meter Telescope design tested in an interferometer with a 2 k×2 k pixel detector, the “null” can be calibrated with respect to a reference sphere over approximately half the bending range required—and it seems likely that extrapolating on the assumption of purely elastic behavior is reasonable. In other cases the “null” could be calibrated using a variety of different techniques, for example, a separate interferometric test or a profiling measuring machine

Operating at null eliminates retrace compensation and eases the interferometer imaging system design. However, this requires a longer cavity than otherwise needed with an attended increase in air turbulence noise. Experience shows, however, that in well designed, temperature controlled areas, adequate repeatability can be achieved in cavities >1 meter long.

As a first order test, we used a toroidal mirror as a simulation of one of the outer segments of the TMT mirror design with radial radius of curvature=65000 mm and a tangential radius of curvature=62500 mm. With a simple fold flat, fringes can only be resolved over the central 25% of the aperture, even with a 2 k×2 k detector.

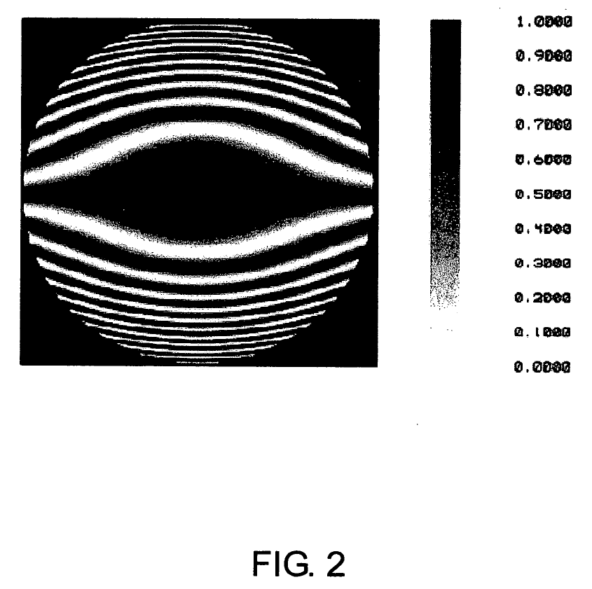

With the fold flat 1 m from the toroid illuminated with a spherical wavefront with an approximately 58.2 m radius of curvature, bending the flat to a spherical radius of curvature of 1.8 km produced the resulting simulated interferogram shown as FIG. 2.

This example simply shows the ease with which astigmatism can be introduced into the test cavity, thus reducing the optical path difference between the segment and reference. Additional low order aberrations (e.g., coma, trefoil) can be bent in as desired.

For testing very long radius of curvature toroids, for example, a plane wave might be used. In this case, the transmission sphere is replaced with a transmission flat (TF)

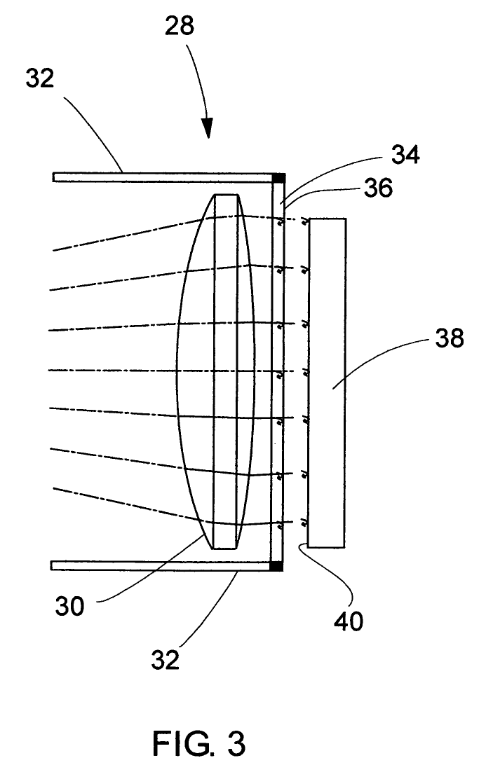

An alternative to bending a flat within the cavity is to bend a transmissive reference surface. This type of arrangement is shown generally at 28 in FIG. 3. Here, beam shaping optics 30 (TS) provide a converging exit beam of predetermined shape followed downstream by a bending harness 32 for flexing a transmission flat 34. The transmission flat 34 has a reference surface 36 that is spaced from a test part 38 whose surface 40 is to be measured. The reference surface 36 is spaced from the test surface 40 by an air gap. If an intermediate radius is chosen for the TS, then power and astigmatism can be bent in to bring the fringe pattern close to null. This approach allows small air gaps between the reference surface and segments under test, which is advantageous for interferometric testing. Bending an element, either the reference surface of the TS (as shown in FIG. 3) or of the fold mirror as in FIG. 1 is intended only to affect the low order aberrations. High frequency surface errors are unaffected (and hence are easily removed by calibration when the system is used with no bending).

This approach may require replacing a singlet TS (assumed for low numerical aperture tests) with an air-spaced doublet. The second element then carries the reference surface and is a near meniscus to ease bending. Design effort is required to control how the imaging and ghost formation are affected by an element with varying astigmatism. As presently envisioned, no attempt would be made to introduce coma in the test sphere, just power and astigmatism to match the segment under test. However, as with the in-cavity fold mirror, there is no fundamental reason why other aberrations cannot be compensated.

For large numerical aperture systems, the TS may comprise multiple elements; the final element carrying the reference surface must be capable of being deformed over the desired dynamic range of the measurement. As noted in the previous section, for specific cases, a plane wave may be used; in this case the single element transmission flat must be bent.

The reference surface can be calibrated in two ways: by bending while measuring a reference sphere (or flat) calibrated as described above. Since elastic bending is linear, reasonable extrapolation beyond the range where fringes are easily resolved introduces minimal additional uncertainty into the measurement. Alternatively, the astigmatism and coma bent into the reference surface can easily be tested by relatively small angle rotations and applying the coordinate transformation first described by Parks (Parks R. E. “Alignment of off-axis conic mirrors” Proc OSA Optical Fabrication and Testing Workshop, 1980, pp 139-45). As an idea of the sensitivity of the method, using one of the outer segments of the TMT design, a rotation of 1 degree will produce 14 um of astigmatism in the wavefront at 45 degrees between the bent reference and the segment where the astigmatism at 0 degrees had been matched. Of the nominally 12.4 um of coma in the wavefront at 0 degrees before rotation, there will be about 0.6 um of coma at 90 degrees after the 1 degree rotation.

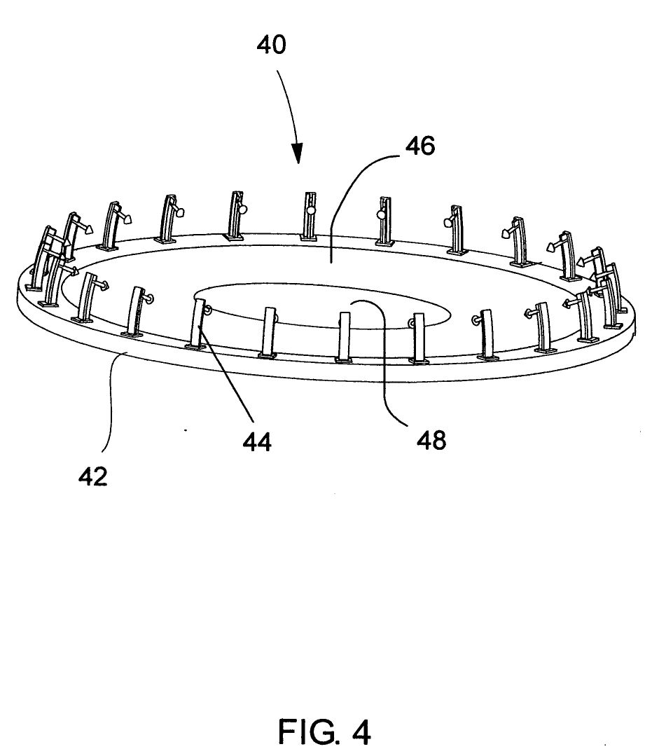

An obvious limit of this invention is the maximum allowable stress. FIG. 4 illustrates a finite element calculation of an arrangement 40 for bending an adaptive optical element in accordance with the invention. Here, a bendable element 42 has attached to its circumferential edge a plurality of equally spaced, upwardly extending cantilevered arms 44 each of which may have selective forces applied to it via a well-known push/pull actuators to exert local discrete edge moments. The analysis shows deformations along the optical or Z-axis where the bendable element 42 is a 40 mm thick Zerodur® (glass-ceramic) mirror blank of the type to be used for the Thirty meter Telescope. For this specific case 200 micrometer peak to valley astigmatic bending can be accommodated well within the elastic limit of the Zerodur®. Illustrated are two regions of deformation 46 and 48 where the deformation in region 46 ranges from 1.638e-004 to 1.023e-004m and in region 48 from 4.082e-005 to −1.539e-007m. Note that light is reflected twice from the fold flat in the in-cavity case; hence the required bending is less than in the transmissive case for a given aspheric departure.

Having described the invention with reference to specific embodiments, those in the art will recognize possible variants based on it teachings, and it is intended that all such variants be within the scope of the invention as claimed.

What is claimed is:

1. An interferometer apparatus for testing aspheric optical segments, said interferometer apparatus comprising:
a support arrangement for holding and manipulating an aspheric optical segment under test;
an adaptive null optic of variable shape located upstream of the aspheric optical segment under test;
a transmission reference optic, having a reference surface, located forward of said adaptive null optic; and
a mainframe interferometer subsystem for generating a known wavefront whose shape matches that of said reference surface and is further modified by said adaptive null optic so that after leaving said adaptive null optic impinges on the aspherical segment under test with a shape substantially matching it.

2. The interferometer apparatus of claim 1 wherein said support arrangement comprises a precision rotatory table and a precision slide arranged for relative motion with respect to one another and wherein at least one of them is arranged to receive and support differently shaped aspheric optical segments to be measured.

3. The interferometer apparatus of claim 1 wherein the shape of said adaptive null optic is controllably changeable by the selective application of external mechanical loads.

4. The interferometer apparatus of claim 3 wherein said external mechanical loads comprise descrete equally spaced bending moments and forces applied locally at the peripheral edges of said adaptive null optics.

5. The interferometer apparatus of claim 1 wherein said adaptive null optic comprises an optical flat.

6. The interferometer apparatus of claim 5 wherein said optical flat is a reflective element.

7. The interferometer apparatus of claim 5 wherein said optical flat comprises a transmissive element.

8. The interferometer apparatus of claim 1 wherein the shape of said known wavefront generated by said mainframe interferometer subsystem is selected from the group consisting plane, spherical, and aspherical wavefronts.

9. The interferometer apparatus of claim 1 wherein said adaptive null optic comprises a flexible mirror arranged between said transmission sphere and an aspheric optical element under test to fold the optical path between them.

10. The interferometer apparatus of claim 1 wherein the elements thereof are arranged in the form of a Fizeau architecture.
